(19) United States
(12) Patent Application Publication
(10) Pub. No.: US 2021/0133594 A1
(43) Pub. Date: May 6, 2021

(54) Augmenting End-to-End Transaction Visibility Using Artificial Intelligence

(71) Applicant: Dell Products L.P., Round Rock, TX (US)

(72) Inventors: Hung T. Dinh, Austin, TX (US); Kiran Kumar Pidugu, SangaReddy (IN); Sabu K. Syed, Austin, TX (US); Lakshman Kumar Tiwari, Uttar Pradesh (IN); Geetha Venkatesan, Bangalore (IN); Sourav Datta, Bangalore (IN); Vijaya P. Sekhar, Bangalore (IN); Kannappan Ramu, Frisco, TX (US); Jatin Kamlesh Thakkar, Bangalore (IN)

(21) Appl. No.: 16/668,947

(22) Filed: Oct. 30, 2019

(51) Int. Cl. G06N 5/02; G06Q 10/10; G06N 20/00

(52) U.S. Cl. CPC G06N 5/02; G06N 20/00; G06Q 10/107

(57) ABSTRACT

Methods, apparatus, and processor-readable storage media for augmenting end-to-end transaction visibility using artificial intelligence are provided herein. An example computer-implemented method includes obtaining data related to multiple transaction flows across multiple data sources within an enterprise system, and forecasting anomalies in connection with at least one of the transaction flows by applying one or more of a first set of artificial intelligence techniques to portions of the obtained data, wherein applying the artificial intelligence techniques is based on which of the multiple data sources correspond to the portions of the obtained data. Such a method further includes determining automated actions to be performed in connection with the forecasted anomalies by applying one or more of a second set of artificial intelligence techniques to portions of the obtained data related to the forecasted anomalies, and performing the automated actions in connection with the at least one transaction flow.

### FIELD

The field relates generally to information processing systems, and more particularly to techniques for processing transaction data in such systems.

### BACKGROUND

Due to large numbers of transactions and related data flows which pass through different technology layers within various enterprise systems, conventional transaction data management approaches face challenges in tracking transactions end-to-end. Additionally, such conventional approaches face further challenges in identifying and/or forecasting particular problem areas in multi-layer transaction data, thereby creating inefficiencies with respect to reprocessing and/or resubmitting problematic transactions.

### SUMMARY

Illustrative embodiments of the disclosure provide techniques for augmenting end-to-end transaction visibility using artificial intelligence. An exemplary computer-implemented method includes obtaining data related to multiple transaction flows across multiple data sources within at least one enterprise system, and forecasting one or more anomalies in connection with at least one of the multiple transaction flows by applying one or more of a first set of artificial intelligence techniques to one or more portions of the obtained data, wherein applying the one or more artificial intelligence techniques is based at least in part on which of the multiple data sources correspond to the one or more portions of the obtained data. Additionally, such a method includes determining one or more automated actions to be performed in connection with the one or more forecasted anomalies by applying one or more of a second set of artificial intelligence techniques to portions of the obtained data related to the one or more forecasted anomalies, and performing the one or more automated actions in connection with the at least one transaction flow.

Illustrative embodiments can provide significant advantages relative to conventional transaction data management approaches. For example, challenges associated with identifying and/or forecasting particular problem areas in multi-layer transaction data are overcome in one or more embodiments through identifying transaction flow anomalies and determining automated actions to be performed in response thereto via application of various artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for augmenting end-to-end transaction visibility using artificial intelligence in an illustrative embodiment.

FIG. 2 shows an artificial intelligence controller in an illustrative embodiment.

FIG. 3 is a flow diagram of a process for augmenting end-to-end transaction visibility using artificial intelligence in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated processing devices. It is to be appreciated, however, that the invention is not restricted to use with the particular illustrative information processing system and device configurations shown. Accordingly, the term “information processing system” as used herein is intended to be broadly construed, so as to encompass, for example, any system comprising multiple networked processing devices.

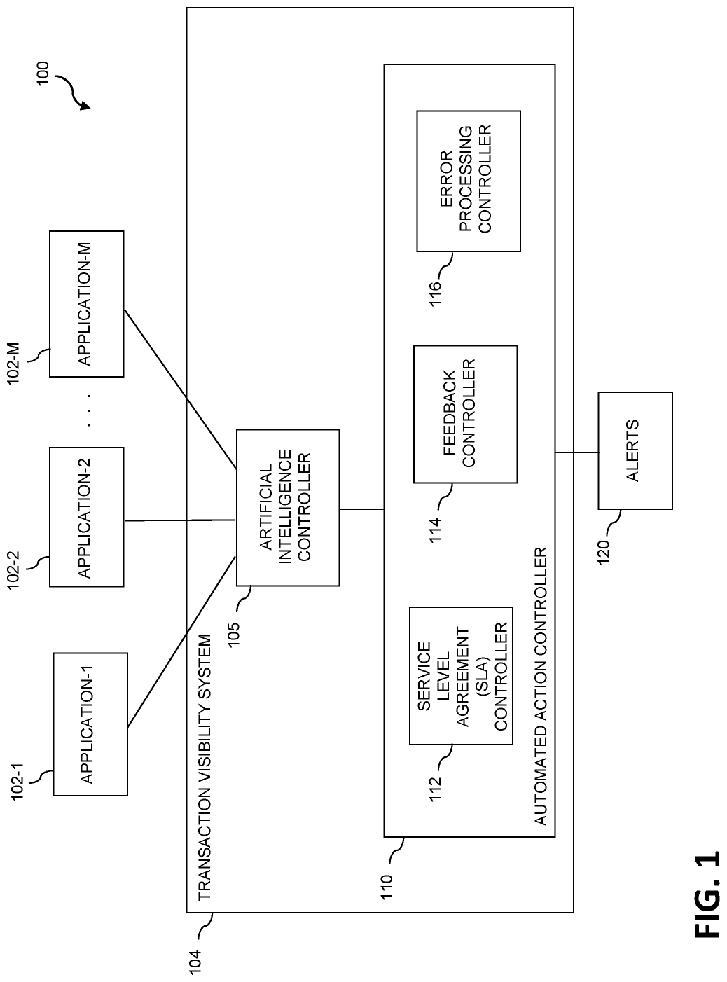

FIG. 1 an information processing system 100 configured in accordance with an illustrative embodiment. The information processing system 100 comprises a plurality of applications 102-1, 102-2, . . . 102-M, collectively referred to herein as applications 102. The applications 102 are coupled to a network, where the network in this embodiment is assumed to represent a sub-network or other related portion of the information processing system 100. Also coupled to the network is transaction visibility system 104. As illustrated in FIG. 1, the transaction visibility system 104 includes an artificial intelligence (AI) controller 105 and an automated action controller 110, which includes a service level agreement (SLA) controller 112, a feedback controller 114, and an error processing controller 116. As depicted in FIG. 1, data from applications 102 are obtained by AI controller 105, which invokes one or more controllers (that is, SLA controller 112, feedback controller 114, and/or errors processing controller 116) of the automated action controller 110 based at least in part on the source of the obtained data. Based on processing of the data carried out by the one or more controllers, an output is generated by the automated action controller 110, wherein such an output includes one or more alerts 120 which trigger at least one automated action (e.g., one or more self-healing mechanisms and/or reprocessing services).

The transaction visibility system 104 may comprise, for example, a laptop computer, tablet computer, desktop computer, mobile telephone or other types of computing devices. Such devices are examples of what are more generally referred to herein as “processing devices.”

The applications 102 in some embodiments are associated with respective processing devices and/or users associated with a particular company, organization or other enterprise. Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

In at least one embodiment, at least portions of the information processing system 100 may be implemented as part of a network. Such a network is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

Additionally, the transaction visibility system 104 can have an associated database configured to store data pertaining to transactions carried out in one or more systems. Such a database in at least one embodiment is implemented using one or more storage systems associated with the transaction visibility system 104. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the transaction visibility system 104 in one or more embodiments are input-output devices, which illustratively comprise keyboards, displays or other types of input-output devices in any combination. Such input-output devices can be used, for example, to support one or more user interfaces to the transaction visibility system 104, as well as to support communication between the transaction visibility system 104 and other related systems and devices not explicitly shown.

Additionally, the transaction visibility system 104 in the FIG. 1 embodiment is assumed to be implemented using at least one processing device. Each such processing device generally comprises at least one processor and an associated memory, and implements one or more functional modules for controlling certain features of the transaction visibility system 104.

More particularly, the transaction visibility system 104 in this embodiment each can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals.

The network interface allows the transaction visibility system 104 to communicate over a network with the user devices (for example, via applications 102), and illustratively comprises one or more conventional transceivers.

It is to be appreciated that this particular arrangement of systems and controllers illustrated in the FIG. 1 embodiment is presented by way of example only, and alternative arrangements can be used in other embodiments. For example, the functionality associated with controllers 105, 110, 112, 114 and 116 in other embodiments can be combined into a single module, or separated across a larger number of modules and/or systems. As another example, multiple distinct processors can be used to implement different ones of the controllers 105, 110, 112, 114 and 116 or portions thereof.

Additionally, at least portions of the controllers 105, 110, 112, 114 and 116 may be implemented at least in part in the form of software that is stored in memory and executed by a processor.

It is to be understood that the particular set of elements shown in FIG. 1 for augmenting end-to-end transaction visibility using artificial intelligence involving information processing system 100 is presented by way of illustrative example only, and in other embodiments additional or alternative elements may be used. Thus, another embodiment includes additional or alternative systems, devices and other network entities, as well as different arrangements of modules and other components.

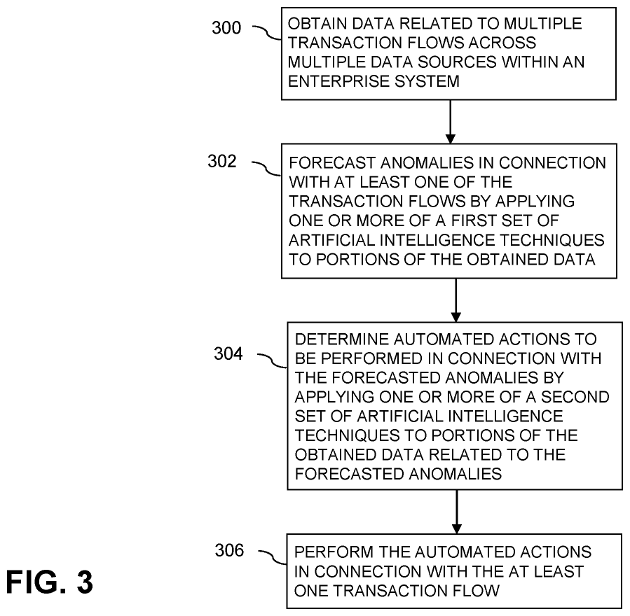

An exemplary process utilizing one or more of controllers 105, 110, 112, 114 and 116 of an example transaction visibility system 104 in information processing system 100 will be described in more detail with reference to the flow diagram of FIG. 3.

Accordingly, at least one embodiment of the invention includes generating and/or implementing an end-to-end transaction visibility system with the capacity to track one or more transactions flowing through various layers of at least one enterprise system, as well as the capacity to forecast and identify problem areas in the tracked transactions and facilitate one or more automated actions (e.g., self-healing mechanisms) in response thereto.

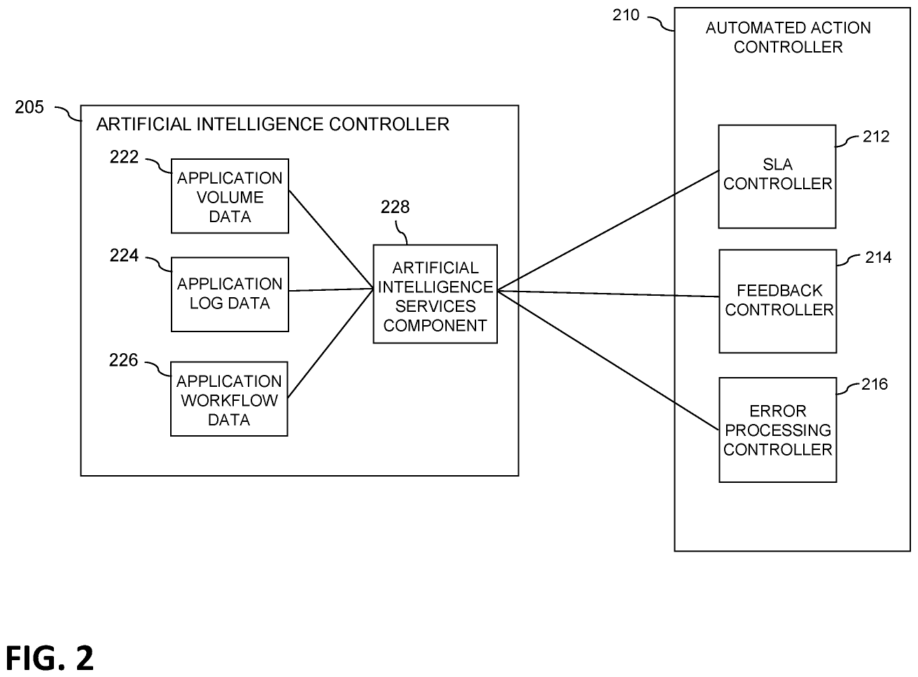

FIG. 2 shows an artificial intelligence controller in an illustrative embodiment. By way of illustration, FIG. 2 depicts interaction between artificial intelligence controller 205 and automated action controller 210 (similar to controllers 105 and 110 in FIG. 1, respectively). As shown in FIG. 2, the artificial intelligence controller 205 includes application volume data 222, application log data 224, and application workflow data 226 (all of which can be obtained, for example, from applications 102, as shown in the FIG. 1 example embodiment). Such data (222, 224 and 226) are processed within the artificial intelligence controller 205 by an artificial intelligence services component 228, which subsequently routes at least portions of the data to different controllers (based at least in part on the type of source data) within the automated action controller. As depicted in FIG. 210, the noted controllers within the automated action controller 210 include SLA controller 212, feedback controller 214 and error processing controller 216. The controllers and one or more of their corresponding functions are discussed further below.

For example, in one or more embodiments, an SLA controller (112/212) carries out performance monitoring with respect to various SLAs by way of implementing one or more AI processes to forecast SLA execution for each of one or more exchanging applications. Such AI processes can include anomaly detection, which includes carrying out application-specific evaluations of acknowledgement performance and identifying one or more anomalous transactions based on the evaluations. The AI processes can also include performance history analysis, which includes autonomous feature generation and preprocessing (e.g., dropping not a number (NaN) values, features scaling and/or capping, etc.) to track performance of each trading application within a given temporal period with respect to one or more identified anomalies. Additionally, such AI processing can include supervised learning, which includes autonomous exploration of one or more supervised learning algorithms and selection of the best model for SLA performance predictions. Further, such AI processes include application programming interface (API) deployment, which includes implementing one or more predefined API designs for real-time performance monitoring based at least in part on one or more user preferences.

Accordingly, at least one embodiment includes utilizing an SLA controller (112/212) to provide a semi-supervised framework that evaluates each application's context individually. Such an embodiment includes anomaly detection (which helps identify instances when SLA performance falters), and deploying one or more autonomous feature engineering techniques to understand near-historical performance distribution. Further, such an embodiment also includes autonomous exploration of machine learning algorithms to generate a predictive model that can preemptively identify SLA performance issues, wherein such predictions are based at least in part on historical performance (triggered per a predetermined temporal interval). Additionally, such an embodiment includes implementing API designs that include email alerts and persistent tracking of anomalous transactions.

Also, in one or more embodiments, an error processing controller (116/216) utilizes one or more machine learning algorithms at each of multiple stages (including, for example, preprocessing, extraction, and forecasting). Such an embodiment includes creating a pattern of errors occurring in different applications (via the use of, e.g., event log data), predicting instances of such errors, sharing the feedback with the respective applications, and initiating remediation of the errors via one or more automated actions. Such machine learning algorithms utilized by the error processing controller can include, for example, k-nearest neighbors (KNN) algorithms, support vector machines (SVMs), Xgboost trees, and neural networks.

Additionally, in one or more embodiments, a feedback controller (114/214) predicts one or more resolution actions for errors (predicted and/or reported) based at least in part on the subject and description of the error in question. An output generated by the feedback controller can include, for example, an email that contains service request information as well as identification of the predicted resolution action.

In such an embodiment, predicting a resolution action at least in part on the subject and description of the error in question can include steps of data collection, data preprocessing, classification, and real-time API implementation. Data collection can include obtaining user input pertaining to a service request that details the error subject and a description thereof (as well as an initial and/or default resolution action for the error). Data preprocessing can include applying a combination of natural language processing (NLP) techniques to the collected data (e.g., clean the data, tokenize the data, vectorize the data, and transform the data). Additionally, classification can include applying one or more supervised learning classification algorithms (e.g., at least one naïve Bayes algorithm (such as MultiNomialNB)) and verifying accuracy of any classification to determine a resolution action for a given error. Further, real-time API implementation includes exposing at least one trained data model as an API that can be applied across multiple service requests.

At least one embodiment also includes determining one or more application-related volume trends. Such an embodiment includes extracting relevant data and performing preprocessing to clean the extracted data. Additionally, such an embodiment includes training the processed data based on count and/or volume information, wherein the training can be carried out in accordance with a predetermined temporal interval. Further, such an embodiment also includes detection of one or more outliers and/or anomalies in recent and/or real-time data based at least in part on one or more statistics (e.g., interquartile range (IQR), one or more empirical method, etc.), one or more clustering techniques, and/or one or more unsupervised machine learning techniques such as long short-term memory (LSTM) algorithms. Such an embodiment can additionally include implementing an automatic email trigger system with respect to detected anomalies and/or threshold breaches.

One or more embodiments also include facilitating auto-recuperation of one or more application and/or system components in response to an occurrence of failure occurring during the downtime of one or more frameworks, and/or in connection with a message lost because of an unanticipated episode (for example, a queue manager crash, a system or server crash, etc.). Such an embodiment includes collecting the identifiers (IDs) of any relevant messages, and when the one or more systems in question resume functionality, implementing at least one trained machine learning-based API to autonomously republish the lost messages.

FIG. 3 is a flow diagram of a process for augmenting end-to-end transaction visibility using artificial intelligence in an illustrative embodiment. It is to be understood that this particular process is only an example, and additional or alternative processes can be carried out in other embodiments.

In this embodiment, the process includes steps 300 through 306. At least a portion of these steps are assumed to be performed by the transaction visibility system 104 utilizing its modules 105 and 110.

Step 300 includes obtaining data related to multiple transaction flows across multiple data sources within at least one enterprise system.

Step 302 includes forecasting one or more anomalies in connection with at least one of the multiple transaction flows by applying one or more of a first set of artificial intelligence techniques to one or more portions of the obtained data, wherein applying the one or more artificial intelligence techniques is based at least in part on which of the multiple data sources correspond to the one or more portions of the obtained data. In at least one embodiment, the first set of artificial intelligence techniques includes one or more machine learning algorithms trained to predict one or more service level agreement performance anomalies. Additionally, in one or more embodiments, the first set of artificial intelligence techniques includes one or more machine learning algorithms trained to predict one or more errors in at least one of the multiple transaction flows. Such machine learning algorithms can include k-nearest neighbor algorithms, support vector machines, decision tree algorithms, and one or more neural networks.

Also, in at least one embodiment, the first set of artificial intelligence techniques includes one or more unsupervised machine learning algorithms trained to predict one or more discrepancies among one or more volume trends attributed to the multiple transaction flows. In such an embodiment, the one or more unsupervised machine learning algorithms include LSTM algorithms.

Step 304 includes determining one or more automated actions to be performed in connection with the one or more forecasted anomalies by applying one or more of a second set of artificial intelligence techniques to portions of the obtained data related to the one or more forecasted anomalies. In at least one embodiment, the second set of artificial intelligence techniques includes one or more natural language processing algorithms and/or one or more supervised learning classification algorithms. In such an embodiment, the supervised learning classification algorithms can include naïve Bayes algorithms.

Step 306 includes performing the one or more automated actions in connection with the at least one transaction flow.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to implement an end-to-end transaction visibility system to track transactions through layers of at least one enterprise system. These and other embodiments can effectively create more time- and resource-efficient enterprise systems.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

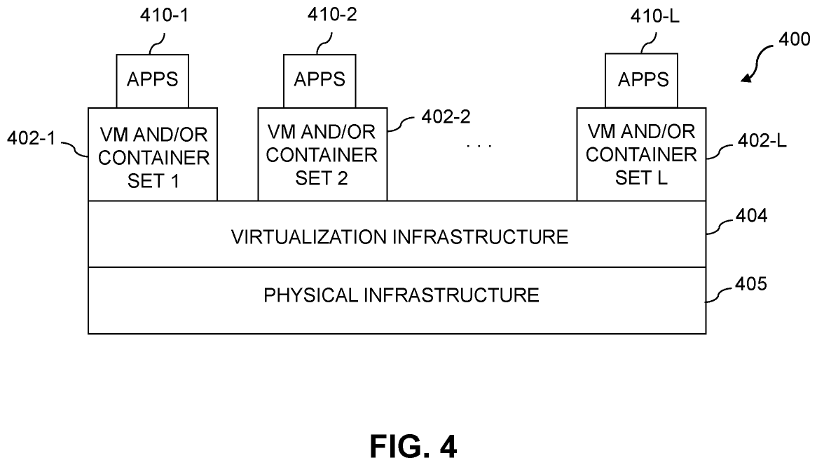

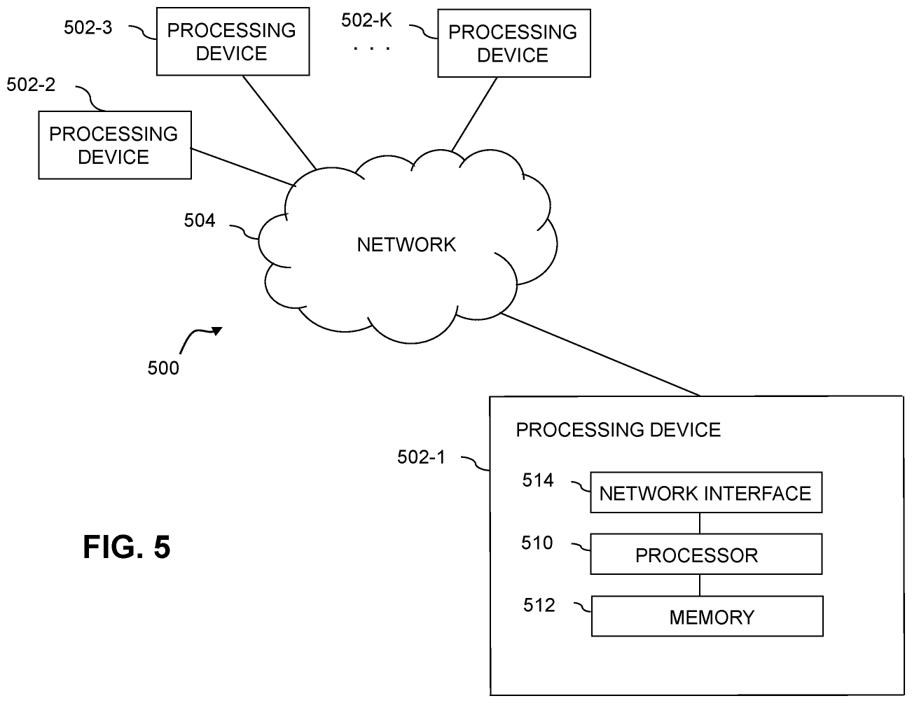

Illustrative embodiments of processing platforms will now be described in greater detail with reference to FIGS. 4 and 5. Although described in the context of information processing system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, wherein the hypervisor platform has an associated virtual infrastructure management system. The underlying physical machines comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of information processing system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a microcontroller, an application-specific integrated circuit (ASIC), a field-programmable gate array (FPGA) or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of information processing systems and devices in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data related to multiple transaction flows across multiple data sources within at least one enterprise system;
forecasting one or more anomalies in connection with at least one of the multiple transaction flows by applying one or more of a first set of artificial intelligence techniques to one or more portions of the obtained data, wherein applying the one or more artificial intelligence techniques is based at least in part on which of the multiple data sources correspond to the one or more portions of the obtained data;
determining one or more automated actions to be performed in connection with the one or more forecasted anomalies by applying one or more of a second set of artificial intelligence techniques to portions of the obtained data related to the one or more forecasted anomalies; and
performing the one or more automated actions in connection with the at least one transaction flow;
wherein the method is performed by at least one processing device comprising a processor coupled to a memory.

2. The computer-implemented method of claim 1, wherein the first set of artificial intelligence techniques comprises one or more machine learning algorithms trained to predict one or more service level agreement performance anomalies.

3. The computer-implemented method of claim 1, wherein the first set of artificial intelligence techniques comprises one or more machine learning algorithms trained to predict one or more errors in at least one of the multiple transaction flows.

4. The computer-implemented method of claim 3, wherein the one or more machine learning algorithms comprise k-nearest neighbor algorithms.

5. The computer-implemented method of claim 3, wherein the one or more machine learning algorithms comprise support vector machines.

6. The computer-implemented method of claim 3, wherein the one or more machine learning algorithms comprise decision tree algorithms.

7. The computer-implemented method of claim 3, wherein the one or more machine learning algorithms comprise one or more neural networks.

8. The computer-implemented method of claim 1, wherein the first set of artificial intelligence techniques comprises one or more unsupervised machine learning algorithms trained to predict one or more discrepancies among one or more volume trends attributed to the multiple transaction flows.

9. The computer-implemented method of claim 8, wherein the one or more unsupervised machine learning algorithms comprise long short-term memory (LSTM) algorithms.

10. The computer-implemented method of claim 1, wherein the second set of artificial intelligence techniques comprises one or more natural language processing algorithms.

11. The computer-implemented method of claim 1, wherein the second set of artificial intelligence techniques comprises one or more supervised learning classification algorithms.

12. The computer-implemented method of claim 11, wherein the one or more supervised learning classification algorithms comprise naïve Bayes algorithms.

13. A non-transitory processor-readable storage medium having stored therein program code of one or more software programs, wherein the program code when executed by at least one processing device causes the at least one processing device:
to obtain data related to multiple transaction flows across multiple data sources within at least one enterprise system;
to forecast one or more anomalies in connection with at least one of the multiple transaction flows by applying one or more of a first set of artificial intelligence techniques to one or more portions of the obtained data, wherein applying the one or more artificial intelligence techniques is based at least in part on which of the multiple data sources correspond to the one or more portions of the obtained data;
to determine one or more automated actions to be performed in connection with the one or more forecasted anomalies by applying one or more of a second set of artificial intelligence techniques to portions of the obtained data related to the one or more forecasted anomalies; and
to perform the one or more automated actions in connection with the at least one transaction flow.

14. The non-transitory processor-readable storage medium of claim 13, wherein the first set of artificial intelligence techniques comprises one or more machine learning algorithms trained to predict one or more service level agreement performance anomalies.

15. The non-transitory processor-readable storage medium of claim 13, wherein the first set of artificial intelligence techniques comprises one or more machine learning algorithms trained to predict one or more errors in at least one of the multiple transaction flows.

16. The non-transitory processor-readable storage medium of claim 13, wherein the first set of artificial intelligence techniques comprises one or more unsupervised machine learning algorithms trained to predict one or more discrepancies among one or more volume trends attributed to the multiple transaction flows.

17. An apparatus comprising:
at least one processing device comprising a processor coupled to a memory;
the at least one processing device being configured:
to obtain data related to multiple transaction flows across multiple data sources within at least one enterprise system;
to forecast one or more anomalies in connection with at least one of the multiple transaction flows by applying one or more of a first set of artificial intelligence techniques to one or more portions of the obtained data, wherein applying the one or more artificial intelligence techniques is based at least in part on which of the multiple data sources correspond to the one or more portions of the obtained data;
to determine one or more automated actions to be performed in connection with the one or more forecasted anomalies by applying one or more of a second set of artificial intelligence techniques to portions of the obtained data related to the one or more forecasted anomalies; and
to perform the one or more automated actions in connection with the at least one transaction flow.

18. The apparatus of claim 17, wherein the first set of artificial intelligence techniques comprises one or more machine learning algorithms trained to predict one or more service level agreement performance anomalies.

19. The apparatus of claim 17, wherein the first set of artificial intelligence techniques comprises one or more machine learning algorithms trained to predict one or more errors in at least one of the multiple transaction flows.

20. The apparatus of claim 17, wherein the first set of artificial intelligence techniques comprises one or more unsupervised machine learning algorithms trained to predict one or more discrepancies among one or more volume trends attributed to the multiple transaction flows.
